(19) United States
(12) Patent Application Publication
(10) Pub. No.: US 2023/0017870 A1
(43) Pub. Date: Jan. 19, 2023

(54) METHODS AND APPARATUS FOR A VAPORIZER DEVICE

(71) Applicant: Jupiter Research, LLC, Phoenix, AZ (US)

(72) Inventors: San Li, Chandler, AZ (US); Jordan Walker, Phoenix, AZ (US); Mark Scatterday, Scottsdale, AZ (US)

(21) Appl. No.: 17/700,773

(22) Filed: Mar. 22, 2022

Related U.S. Application Data
(60) Provisional application No. 63/221,410, filed on Jul. 13, 2021.

(51) Int. Cl. A24F 40/46; A24F 40/30; A24F 40/57; A24F 40/20; H05B 3/42; H05B 1/02

(52) U.S. Cl. CPC A24F 40/46; A24F 40/30; A24F 40/57; A24F 40/20; H05B 3/42; H05B 1/0244; H05B 2203/005; H05B 2203/017

(57) ABSTRACT

Methods and apparatus for a vaporizer device according to various aspects of the subject technology may include an atomizer and a control circuit. The atomizer may include a plurality of chambers including a first chamber and a second chamber. The atomizer may also include a plurality of heating elements including a first heating element and a second heating element. The first heating element may be configured to apply heat to the first chamber in response to being enabled, and the second heating element may be configured to apply heat to the second chamber in response to being enabled. The control circuit may be configured to sequentially enable the plurality of heating elements.

### CROSS-REFERENCE TO RELATED APPLICATION

This application claims the benefit of U.S. Provisional Patent Application Ser. No. 63/221,410, filed on Jul. 13, 2021, and incorporates the disclosure of the application in its entirety by reference.

### BACKGROUND OF THE TECHNOLOGY

### State of the Art

“Vape” devices, IQOS devices, and heat-not-burn (HNB) devices (i.e., collectively, “vaporizer” devices) present an alternative to smoking and work by vaporizing a consumable flower, such as cannabis, tobacco, etc. by heating the consumable flower at a lower temperature than an open flame so that a user can inhale the flower in vapor form, rather than smoke.

A conventional vaporizer device typically has a chamber for holding the flower and a small, heated coil in contact with the chamber. A current is typically passed through the coil, thereby heating the chamber which in turn heats the flower. However, the flower contained in the chamber of a conventional vaporizer device is prone to heating unevenly. Specifically, the portion of the flower closest to the heated chamber is prone to overheat while the portion of the flower farthest away from the heated chamber is prone to underheat. Thus, the portion of the flower closest to the heated chamber commonly combusts, thereby increasing the presence of potentially harmful irritants that may be contained in flower smoke.

Accordingly, what is needed is a method and apparatus to regulate the temperature of the chamber to evenly heat the entire flower to a temperature just below its combustion point so that the user can be provided with a high-quality vapor and improved flavor over the lifetime of the flower.

### SUMMARY OF THE TECHNOLOGY

Methods and apparatus for a vaporizer device according to various aspects of the subject technology may comprise an atomizer and a control circuit. The atomizer may comprise a plurality of chambers comprising a first chamber and a second chamber. The atomizer may also comprise a plurality of heating elements comprising a first heating element and a second heating element. The first heating element may be configured to apply heat to the first chamber in response to being enabled, and the second heating element may be configured to apply heat to the second chamber in response to being enabled. The control circuit may be configured to sequentially enable the plurality of heating elements.

### BRIEF DESCRIPTION OF THE DRAWINGS

A more complete understanding of the subject technology may be derived by referring to the detailed description when considered in connection with the following illustrative figures. In the following figures, like reference numbers refer to similar elements and steps throughout the figures.

FIG. 1 is a block diagram of a vaporizer system in accordance with an embodiment of the subject technology;

FIG. 2 is a block diagram of a portion of a vaporizer system in accordance with an embodiment of the subject technology;

FIG. 3 representatively illustrates an atomizer in accordance with an embodiment of the subject technology;

FIG. 4 representatively illustrates an atomizer in accordance with an embodiment of the subject technology;

FIG. 5 representatively illustrates an atomizer in accordance with an embodiment of the subject technology;

FIG. 6 representatively illustrates a vaporizer system, with an atomizer, in accordance with an embodiment of the subject technology; and

FIG. 7 is a flow chart for using an atomizer to vaporize a vaporizable material in accordance with an embodiment of the subject technology.

### DETAILED DESCRIPTION OF EMBODIMENTS

The subject technology may be described in terms of functional block components. Such functional blocks may be realized by any number of components configured to perform the specified functions and achieve the various results. For example, the subject technology may employ various atomizers, batteries, chambers, circuitry, coils, heating elements, inlets, logic components, outlets, processors, sensors, wires, and the like, which may carry out a variety of functions. In addition, the subject technology may be practiced in conjunction with any one of various vaporizer systems, and the atomizer described herein is merely one exemplary application for the technology.

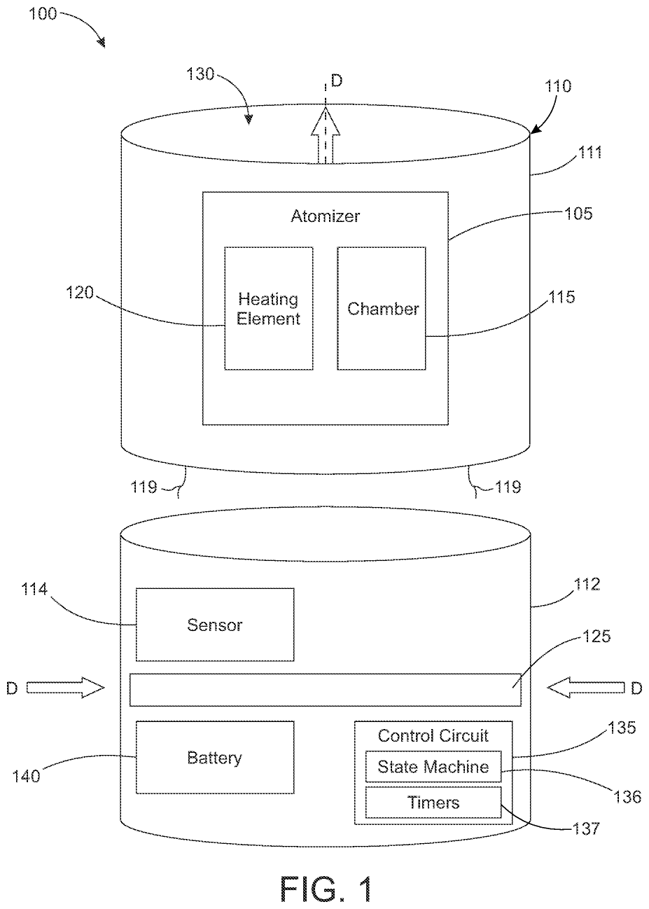

Referring to FIGS. 1-6, in various embodiments, a vaporizer system 100 may comprise an atomizer 105 adapted to be inserted into a housing 111 of a “vape” device, IQOS device, or heat-not-burn device (the “vaporizer device 110”). The atomizer 105 may comprise a plurality of chambers 115 disposed within the atomizer 105, where each chamber 115 may be configured to hold a vaporizable material, such as cannabis flower, tobacco flower, and the like. The atomizer 105 may also comprise a plurality of heating elements 120 disposed within the atomizer 105. The plurality of heating elements 120 may be in contact with the plurality of chambers 115 and may heat the vaporizable material to a temperature sufficient to vaporize the vaporizable material. The vaporizer system 100 may further comprise a base portion 112 comprising a control circuit 135 for controllably operating the plurality of heating elements 120 and a battery 140 for supplying power to various components of the vaporizer system 100.

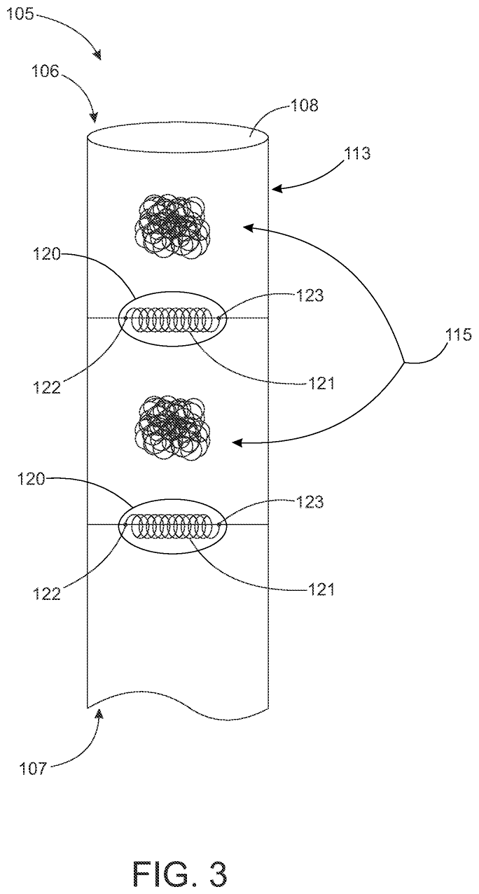

The atomizer 105 may be of any suitable size and shape such that the entire atomizer 105 may be fitted into the housing 111 of the vaporizer device 110. According to various embodiments, and referring now to FIGS. 3-6, the atomizer 105 may comprise a first end 106, a second end 107 opposite the first end 106, an interior surface 108, and an exterior surface 109. The interior surface 108 of the atomizer 105 may be constructed from a variety of suitable thermally conductive materials, such as metal, ceramic silicone, glass, or any other combination of thermally conductive materials. The exterior surface 109 of the atomizer 105 may be constructed from a variety of suitable materials, such as ceramic, paper, pulp, and silicone.

Each heating element 120 may comprise any suitable resistive element that dissipates heat when an electric current flows through it. For example, each heating element 120 may comprise a coil, ribbon (straight or corrugated), strip of wire, wire mesh, or the like. In one embodiment, each heating element 120 may comprise a coil 121 having a first end 122 and a second end 123. The coil 121 may be of any suitable size and shape such that it may fit within the atomizer 105. The coil 121 may be constructed from a variety of suitable materials, such as nickel, iron, stainless steel, or a combination thereof. In addition, the coil 121 may have any suitable resistance so long as the coil 121 dissipates enough heat to heat the vaporizable material to a temperature sufficient to vaporize the vaporizable material. For example, in the case where the vaporizable material is cannabis flower, the flower within each chamber 115 may be heated to a temperature of approximately 215 to 480° F. to create an aerosolized vapor therefrom.

In some embodiments, each heating element 120 may also comprise one or more wires coupled to the first end 122 and the second end 123 of the coil 121 for connecting the coil 121 to various components of the vaporizer system 100. It will be appreciated that the wires connected to the first ends 122 of the coils 121 may be connected to each other and the wires connected to the second ends 123 of the coils 121 may be connected to each other to create two wire connections 119, such as shown in FIG. 1. Each wire may be constructed from any suitable heat-resistant material, such as nickel-chromium, stainless steel, and the like.

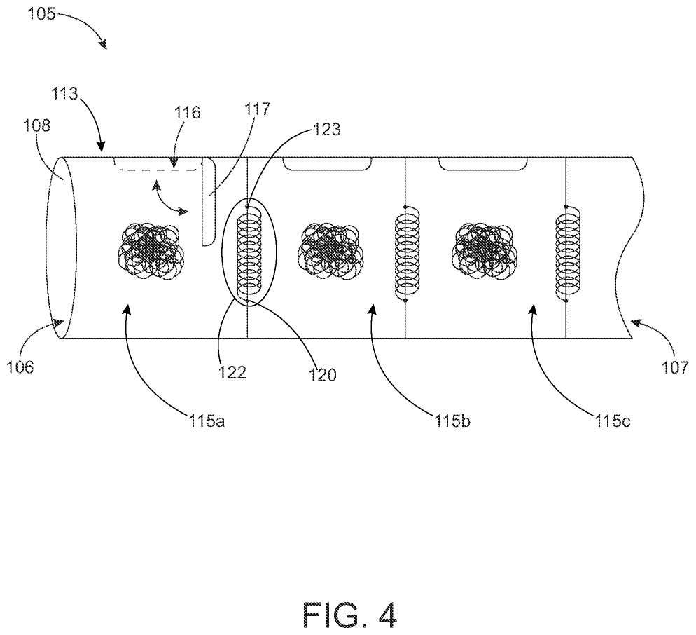

Referring now to FIG. 4, the plurality of heating elements 120 may be disposed along a longitudinal axis of the atomizer 105. Accordingly, the plurality of heating elements 120 and the interior surface 108 of the atomizer 105 may define the plurality of chambers 115. In one embodiment, the plurality of chambers 115 may comprise a first chamber 115a, a second chamber 115b, and a third chamber 115c. In this embodiment, the chambers 115a, 115b, and 115c may be of the same size and shape such that each chamber 115a, 115b, and 115c may hold the same amount of vaporizable material. In addition, each chamber 115a, 115b, and 115c may comprise an opening 116 to allow a user to fill each chamber 115a, 115b, and 115c with vaporizable material. Each chamber 115a, 115b, and 115c may also comprise a cover 117 configured to move, relative to the atomizer 105, between an open position and a closed position. Accordingly, each chamber 115a, 115b, and 115c may be filled with the vaporizable material via its opening 116 when its cover 117 is in the open position, and the vaporizable material may be prevented from falling out of the chamber 115a, 115b, and 115c when its cover 117 is in the closed position.

It will be appreciated that modifications may be made to the atomizer 105 without departing from the scope of the subject technology. For example, the plurality of chambers 115 may be designed such that their cross-sectional areas are minimized so that the entire vaporizable material contained in the atomizer 105 may be heated evenly.

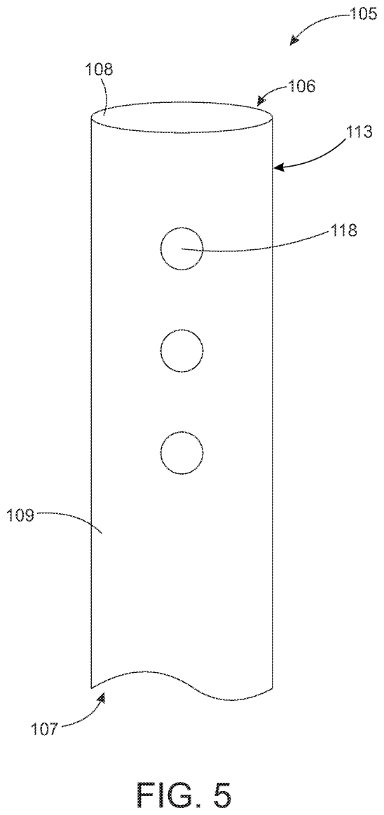

In addition, and referring now to FIG. 5, each chamber 115 may comprise a plurality of perforations 118, where each perforation 118 may be sealed with any suitable meltable material, e.g., wax. Accordingly, when a particular chamber 115 is heated via one of the plurality of heating elements 120, the wax covering its respective perforation 118 may melt so that once the vapor is produced inside the chamber 115, it may escape the chamber 115 to mix with the air drawn into the atomizer 105. The resulting aerosol (vapor and airflow) may then travel as an aerosol stream along an airflow path D where it may be expelled via an outlet 130 of the vaporizer device 110 and inhaled through a mouthpiece (not shown) coupled to the outlet 130.

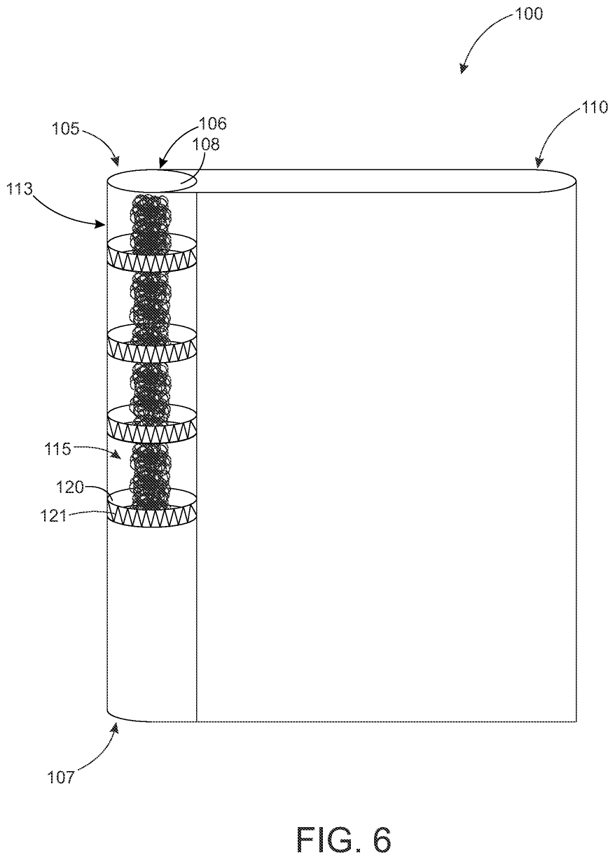

In another embodiment, and referring now to FIG. 6, the atomizer 105 may comprise a single chamber 115 disposed within the atomizer 115. In this case, the plurality of heating elements 120 disposed within the atomizer 105 may be “banded” heating elements, such that each heating element 120 may be annular-shaped and may be disposed along the interior surface 108 of the atomizer 105 so that the entire vaporizable material may be surrounded or enclosed by the plurality of heating elements 120. The plurality of heating elements 120 may be formed on the interior surface 108 of the atomizer 105 in any suitable manner, such as by printing the plurality of heating elements 120 onto the interior surface 108. The interior surface 108 may be constructed from a variety of suitable flexible substrates, such as thermoplastic polyurethanes (TPU), polyimide (PI), polyester (PET), Kapton RS conductive film, and the like.

It will be understood that the atomizer 105 may include an embodiment defined as a container 113, which may be used to hold the vaporizable material and transfer heat from at least one of the plurality of chambers 1150 to the vaporizable material for vaporization. For example, and referring now to FIGS. 3-6, the vaporizer system 100 may comprise the container 113, and the container 113 may be configured to hold the vaporizable material. The container 113 may be of any suitable size and shape, such that it may be fitted into the vaporizer device 110. As an example, the container 113 may comprise a cylindrical-shaped body.

In some embodiments, the container 113 may comprise a plurality of heating elements 120 disposed within the container 113. In one embodiment, the plurality of heating elements 120 may comprise “banded” heating elements, such that each heating element 120 may be annular-shaped and may be disposed along the interior surface 108 of the container 113 so that the vaporizable material may be surrounded or enclosed by the plurality of heating elements 120. The plurality of heating elements 120 may be connected to various components of the vaporizer system 100, including, but not limited to, the battery 140 when the container 113 is fitted into the vaporizer device 110.

According to various embodiments, the control circuit 135 may comprise a state machine 136. The state machine 136 may be configured to receive inputs from various components and from timers 137. In addition, the state machine 136 may be configured to provide a plurality of control signals, i.e., enable and disable signals, to the various component of the system 100. The control circuit 135, including the functionality of the state machine 136, may be implemented using a variety of different logic components, processors, associated configuration data and/or stored programming instructions.

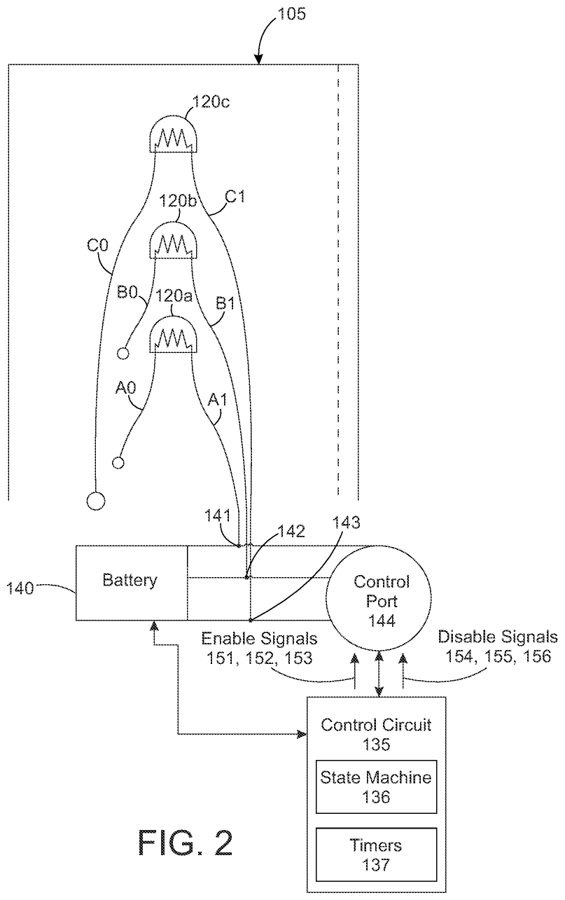

As an example, and referring now to FIG. 2, the plurality of heating elements 120 may comprise a first heating element 120a, a second heating element 120b, and a third heating element 120c. The first heating element 120a may comprise a first pair of wires, A, comprising two wires A0 and A1. The second heating element 120b may comprise a second pair of wires, B, comprising two wires B0 and B1. The third heating element 120c may comprise a third pair of wires, C, comprising two wires C0, C1. Wires A0, B0, and C0 may each be connected to a ground node or reference node, and wires A1, B1, and C1 may each be connected to the battery 140 at a first port 141, a second port 142, and a third port 143, respectively.

The first, second, and third ports 141, 142, 143 may be connected to a control port 144. The control port 144 may be connected to the control circuit 135 for receiving, via the state machine 136, a first enable signal 151, a second enable signal 152, a third enable signal 153, a first disable signal 154, a second disable signal 155, and a third disable signal 156. The control port 144 may be configured to enable the first, second, and third ports 141, 142, 143 in response to receiving the first, second, and third enable signals 151, 152, 153, respectively. Similarly, the control port 144 may be further configured to disable the first, second, and third ports 141, 142, 143 in response to receiving the first, second, and third disable signals 154, 155, 156, respectively.

In other embodiments, each port 141, 142, 143 may be configured to receive and respond to its own respective enable signal and disable signal, wherein the enable signal and the disable signal received at the first port 141 may be different than the enable signal and the disable signal received at the second port 142, respectively. Likewise, the enable and disable signals received at the first and second ports 141, 142 may be different than the enable signal and the disable signal received at the third port 143.

The control circuit 135 may be configured to enable and disable the plurality of heating elements 120. In an embodiment, the control circuit 135 may be configured to enable the plurality of heating elements 120 sequentially. The plurality of heating elements 120 may be enabled sequentially according to predetermined programming instructions stored in the control circuit 135. For example, when the vaporizer device 110 is turned on, the first heating element 120a may be enabled during a first time period. During the first time period, the battery 140 may supply a current to the first heating element 120a via wire A1. At the end of the first time period, the first heating element 120a may be disabled and the second heating element 120b may be enabled during a second time period. During the second time period, the battery 140 may supply a current to the second heating element 120b via wire B1. At the end of the second time period, the second heating element 120b may be disabled and the third heating element 120c may be enabled during a third time period. During the third time period, the battery 140 may supply a current to the third heating element 120c via wire C1. At the end of the third time period, the third heating element 120c may be disabled. The plurality of heating elements 120 may, however, be enabled in any suitable manner, such as by a user via one or more user inputs

In some embodiments, only one heating element 120 may be enabled at a time to provide heat to one section of the atomizer 105 at a time. Referring to the example described above, the second time period may immediately follow the first time period, and the third time period may immediately follow the second time period. For example, following turning on the vaporizer device 110, the state machine 136 may instruct the control circuit 135 to enable: the first heating element 120a from 1 second to 10 seconds; the second heating element 120b from 11 seconds to 20 seconds; and the third heating element 120c from 21 seconds to 30 seconds.

In other embodiments, more than one heating element may be enabled at the same time. Referring to the example described above, the second time period may overlap with the first time period, and the third time period may overlap with the second time period. For example, following turning on the vaporizer device 110, the state machine 136 may instruct the control circuit 135 to enable: the first heating element 120a from 1 second to 10 seconds; the second heating element 120b from 5 seconds to 15 seconds; and the third heating element 120c from 10 seconds to 20 seconds.

It will be appreciated that modifications may be made to the manner in which the plurality of heating elements 120 may be enabled and/or disabled without departing from the scope of the subject technology. Furthermore, because the amount of heat generated by the plurality of heating elements 120 may be proportional to the amount of current supplied to the plurality of heating elements 120 by the battery 140, the control circuit 135 may control the amount of current, and thus heat, that is emitted by the plurality of heating elements 120. For instance, one heating element may provide more heat than another heating element. Further, during operation, each heating element 120 may be enabled more than one time, e.g., 2-4 times.

The battery 140 may be a power supply for the vaporizer system 100 and may comprise any suitable disposable, replaceable, or rechargeable battery, such as an alkaline battery, a lead acid battery, a nickel cadmium battery, a nickel metal hydride battery, a lithium-ion battery, and the like. It will be appreciated that modifications may be made to the battery 140 without departing from the scope of the subject technology. For example, instead of the battery 140, alternative energy sources, such as inductive, solar, and chemical energy sources, may be used to power the plurality of heating elements 120.

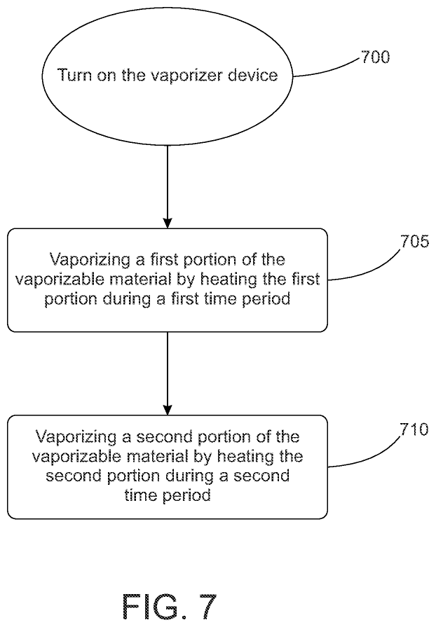

In operation, and referring now to FIGS. 1-7, using the atomizer 105 to vaporize the vaporizable material may comprise turning on the vaporizer device 110 (700). The vaporizer device 110 may be turned on by a sensor 114, which may be an airflow or other type of trigger sensor, or by pressing a button or switch. For example, in the case where the vaporizer device 110 is “draw-activated”, a user may turn on the vaporizer device 110 by drawing air into the vaporizer device 110 via an inlet 125 by inhaling through the mouthpiece connected to the outlet 130. When the user inhales, a negative pressure may be induced inside the vaporizer device 110. The negative pressure induced inside the vaporizer device 110 may cause the sensor 114 to close a pressure switch (not shown), thereby closing the circuit between the battery 140 and the various components of the vaporizer system 100. Once the pressure switch (not shown) is closed, the battery 140 may supply power to the various components of the vaporizer device 110, including the control circuit 135. The control circuit 135, via the state machine 136, may control when the various heating elements 120 can be powered on or powered off.

Referring to the example described at paragraph [0025] of this application, using the atomizer 105 to vaporize the vaporizable material may comprise vaporizing a first portion of the vaporizable material by heating the first portion during a first time period (705). Once the vaporizer device 110 is turned ON, the control circuit 135, via the state machine 136, may send the first enable signal 151 to the control port 144. The control port 144, which may be connected to the first heating element 120a, may enable the first heating element 120a in response to receiving the first enable signal 151. Once the first heating element 120a is enabled, the battery 140 may supply a current to the first heating element 120a, such that the first heating element 120a may dissipate heat when the current flows through it. Because the first heating element 120a may be in contact with the first chamber 115a, the first heating element 120a may vaporize the first portion of the vaporizable material by heating the first chamber 115a to a temperature sufficient to generate the vapor.

Following the end of the first time period, the control circuit 135, via the state machine 136, may send the first disable signal 154 to the control port 144. The control port 144 may disable the first heating element 120a in response to receiving the first disable signal 154. At this time, using the atomizer 105 to vaporize the vaporizable material may comprise vaporizing a second portion of the vaporizable material by heating the second portion during a second time period (710). Following the end of the first time period, the control circuit 135, via the state machine 136, may send the second disable signal 155 to the control port 144. The control port 144, which may be connected to the second heating element 120b, may enable the second heating element 120b in response to receiving the second enable signal 152. Once the second heating element 120b is enabled, the battery 140 may supply a current to the second heating element 120b, such that the second heating element 120b may dissipate heat when the current flows through it. Because the second heating element 120b may be in contact with the second chamber 115b, the second heating element 120b may vaporize the second portion of the vaporizable material by heating the second chamber 115b to a temperature sufficient to generate the vapor.

The second time period may immediately follow the first time period. Accordingly, the control circuit 135 may send a variety of control signals, i.e., enable signals and disable signals to sequentially activate the first heating element 120a and the second heating element 120b. Each heating element 120a, 120b may be enabled more than one time, e.g., such as 2-4 times, to heat and vaporize the vaporizable material inside the first chamber 115a and the second chamber 115b. Once the vapor is produced, it may mix with the air drawn into the atomizer 105 via the inlet 125, and the resulting aerosol (vapor and airflow) may travel as an aerosol stream along the airflow path D where it may be expelled via the outlet 130 and inhaled through the mouthpiece.

The particular implementations shown and described are illustrative of the technology and its best mode and are not intended to otherwise limit the scope of the subject technology in any way. Indeed, for the sake of brevity, conventional manufacturing, connection, preparation, and other functional aspects of the apparatus may not be described in detail. Furthermore, the connections and points of contact shown in the various figures are intended to represent exemplary physical relationships between the various elements. Many alternative or additional functional relationships or physical connections may be present in a practical system.

In the foregoing description, the technology has been described with reference to specific embodiments. Various modifications and changes may be made, however, without departing from the scope of the subject technology as set forth. The description and figures are to be regarded in an illustrative manner, rather than a restrictive one and all such modifications are intended to be included within the scope of the subject technology. Accordingly, the scope of the technology should be determined by the generic embodiments described and their legal equivalents rather than by merely the specific examples described above. For example, the components and/or elements recited in any apparatus embodiment may be combined in a variety of permutations to produce substantially the same result as the subject technology and are accordingly not limited to the specific configuration recited in the specific examples.

Benefits, other advantages, and solutions to problems have been described above with regard to particular embodiments. Any benefit, advantage, solution to problems or any element that may cause any particular benefit, advantage, or solution to occur or to become more pronounced, however, is not to be construed as a critical, required, or essential feature or component.

The terms “comprises,” “comprising,” or any variation thereof, are intended to reference a non-exclusive inclusion, such that a process, method, article, composition, or apparatus that comprises a list of elements does not include only those elements recited but may also include other elements not expressly listed or inherent to such process, method, article, composition, or apparatus. Other combinations and/or modifications of the above-described structures, arrangements, applications, proportions, elements, materials, or components used in the practice of the subject technology, in addition to those not specifically recited, may be varied, or otherwise particularly adapted to specific environments, manufacturing specifications, design parameters or other operating requirements without departing from the general principles of the same.

The subject technology has been described above with reference to an embodiment. However, changes and modifications may be made to the embodiment without departing from the scope of the subject technology. These and other changes or modifications are intended to be included within the scope of the subject technology.

1. A vaporizer system, comprising:
an atomizer, comprising:
a plurality of chambers comprising a first chamber and a second chamber; and
a plurality of heating elements, comprising:
a first heating element configured to apply heat to the first chamber in response to being enabled;
a second heating element configured to apply heat to the second heating element in response to being enabled; and
a control circuit configured to sequentially enable the plurality of heating elements.

2. The vaporizer system of claim 1, wherein:
the atomizer comprises a cylindrical-shaped body; and
the plurality of heating elements are printed onto an interior surface of the cylindrical-shaped body.

3. The vaporizer system of claim 1, wherein:
the first heating element is configured to be enabled during a first time period and disabled during a second time period;
the second heating element is configured to be enabled during the second time period and disabled during the first time period; and
the second time period immediately follows the first time period.

4. The vaporizer system of claim 3, wherein the first time period and the second time period are each 10 seconds.

5. The vaporizer system of claim 3, further comprising a control port connected to the control circuit and configured to receive a first enable signal, a first disable signal, a second enable signal, and a second disable signal.

6. The vaporizer system of claim 5, wherein the control circuit is configured to:
enable the first heating element by sending the first enable signal to the control port;
disable the first heating element by sending the first disable signal to the control port;
enable the second heating element by sending the second enable signal to the control port; and
disable the second heating element by sending the second disable signal to the control port.

7. The vaporizer system of claim 6, wherein the control circuit comprises a timer and is further configured to function as a state machine that responds to the timer and controllably operates the plurality of heating elements by:
enabling the first heating element at the start of the first time period;
disabling the first heating element following the end of the first time period;
enabling the second heating element at the start of the second time period; and
disabling the second heating element following the end of the second time period.

8. An atomizer for use with a vaporizer device, comprising:
a plurality of chambers comprising a first chamber and a second chamber; and
a plurality of heating elements, comprising:
a first heating element configured to apply heat to the first chamber in response to being enabled; and
a second heating element configured to apply heat to the second chamber in response to being enabled.

9. The atomizer of claim 8, wherein:
the atomizer comprises a cylindrical-shaped body; and
the plurality of heating elements are printed onto an interior surface of the cylindrical-shaped body.

10. The atomizer of claim 8, wherein the plurality of heating elements are enabled sequentially.

11. The atomizer of claim 10, wherein:
the first heating element is enabled during a first time period and disabled during a second time period;
the second heating element is enabled during the second time period and disabled during the first time period; and
the second time period immediately follows the first time period.

12. The atomizer of claim 11, wherein the first time period and the second time period are each 10 seconds.

13. A method of using an atomizer to vaporize a vaporizable material, comprising:
vaporizing a first portion of the vaporizable material by heating the first portion during a first time period; and
vaporizing a second portion of the vaporizable material by heating the second portion during a second time period.

14. The method of claim 13, wherein:
heating the first portion of the vaporizable material comprises utilizing a first heating element to apply heat to the first portion in response to being enabled;
heating the second portion of the vaporizable material comprises utilizing a second heating element to apply heat to the second portion in response to being enabled; and
the first heating element and the second heating element are enabled sequentially.

15. The method of claim 14, wherein:
heating the first portion of the vaporizable material further comprises:
enabling the first heating element during the first time period; and
disabling the first heating element during the second time period;
heating the second portion of the vaporizable material further comprises:
enabling the second heating element during the second time period; and
disabling the second heating element during the first time period; and
the second time period immediately follows the first time period.

16. The method of claim 15, wherein the first time period and the second time period are each 10 seconds.
